(19) United States
(12) Patent Application Publication
(10) Pub. No.: US 2016/0156811 A1
(43) Pub. Date: Jun. 2, 2016

(54) COLOR ADJUSTMENT METHOD

(71) Applicant: SEIKO EPSON CORPORATION, Tokyo (JP)

(72) Inventors: Kohei IWAMOTO, Matsumoto-shi (JP); Tatsuro OSHIKAWA, Shiojiri-Shi (JP); Kazumi YAMADA, Azumino-Shi (JP); Satoru ONO, Shiojiri-Shi (JP)

(73) Assignee: SEIKO EPSON CORPORATION, Tokyo (JP)

(21) Appl. No.: 14/948,646

(22) Filed: Nov. 23, 2015

(30) Foreign Application Priority Data
Dec. 1, 2014 (JP) 2014-242872

(51) Int. Cl. H04N 1/60; B41J 2/21

(52) U.S. Cl. CPC H04N 1/6033; H04N 1/6008; B41J 2/21

(57) ABSTRACT

A color adjustment method includes: selecting, as a first color, a color of a color adjustment region in an image region of image data, from a color sample table printed on a medium similar to a medium to be used when an image based on the image data is printed (steps S1, S2); printing a color variable chart in which a plurality of colors are arranged with the first color at a center, on a medium similar to the medium to be used when the image is printed (step S4); selecting, as a second color, a color to be used for color adjustment in the color adjustment region, from the printed color variable chart (steps S5, S6); and converting the color of the color adjustment region in the image data into the second color (step S7).

### BACKGROUND

1. Technical Field

The present invention relates to a color adjustment method for adjusting a color of an image to be printed on a medium.

2. Related Art

Color adjustment devices that adjust, in printing, colors of images by using color profiles so as to match the colors of image data displayed on displays with the colors of the images printed on media by printers are known. In a color adjustment device of JP-A-2004-282156 as a color adjustment device of this type, when a region where color adjustment is required is selected as a color adjustment region in image data displayed on the display, a color variable chart in which a plurality of colors are arranged with a color of the color adjustment region at a center is created. Then, when one of the colors in the color variable chart is selected as a color for color adjustment, the color of the color adjustment region is adjusted on the basis of the color selected for the color adjustment when the image data is printed on a medium. Thus, a color adjustment operation for matching the color of image data with the color of the image printed by a printer is performed.

In the color adjustment device of JP-A-2004-282156, if a medium on which an image is actually printed is different from a medium on which a color variable chart is printed, even when a desired color is selected as a color for color adjustment from the color variable chart, the color of the image actually printed on the medium may be different from the desired color selected in the color variable chart.

### SUMMARY

An advantage of some aspects of the present invention is to provide a color adjustment method capable of reducing a color difference between a color of image data and a color of an image actually printed on a medium on the basis of the image data.

Means of some aspects of the invention and effects thereof will be explained below.

A color adjustment method according to an aspect of the invention includes: selecting, as a first color, a color of a color adjustment region in an image region of image data, from a color sample table printed on a medium similar to a medium to be used when an image based on the image data is printed; printing a color variable chart in which a plurality of colors are arranged with the first color at a center, on a medium similar to the medium to be used when the image is printed; selecting, as a second color, a color to be used for color adjustment in the color adjustment region, from the printed color variable chart; and converting the color of the color adjustment region in the image data into the second color.

According to the feature, a color for color adjustment of the color adjustment region in image data is selected by using the color sample table and the color variable chart printed on media similar to the medium to be actually used when an image based on the image data is printed. Then, the color of the color adjustment region in the image data is adjusted by using the color selected in such a manner. Therefore, a color difference between the color of the image data and the color of the image actually printed on a medium on the basis of the image data can be reduced.

In the above color adjustment method, it is preferable that the color sample table and the color variable chart be printed by a same printing device.

As with a case where a color to be printed may vary among media even if a same image is printed, there is a case where a color to be printed may vary among printing devices for each type thereof or each product. According to the preferable feature, a color sample table and a color variable chart are printed by using the same printing device, and thereby an occurrence of variation in color due to printing devices can be suppressed.

In the above color adjustment method, it is preferable that the color sample table be printed so as to include an entire range of colors that the printing device can print, including the color variable chart.

According to the preferable feature, a color selection range in the color sample table for the first color selection process can be enlarged.

In the above color adjustment method, it is preferable that, in the color sample table, a plurality of patch images be arranged in a vertical direction and a horizontal direction, that a hue change along one of the vertical direction and the horizontal direction, and that one of a lightness and a chroma change along the other of the vertical direction and the horizontal direction.

According to the preferable feature, the patch images adjacent to each other have colors similar to each other in the color sample table used in the first color selection process, thereby making it easier to find out a desired color, as a color for color adjustment, from the color sample table, compared to a case of using a color sample table in which patch images having similar colors are arranged apart from each other.

In the above color adjustment method, it is preferable that, in selecting the first color, a positional information of the patch image in the color sample table be selected.

According to the preferable feature, the color selected from the color sample table and the positional information of the color are confirmed, and thereby selecting of a wrong color from the color sample table can be suppressed.

In the above color adjustment method, it is preferable that the color variable chart be displayed by using RGB values or CMY values.

### BRIEF DESCRIPTION OF THE DRAWINGS

The invention will be described with reference to the accompanying drawings, wherein like numbers reference like elements.

FIG. 1 is a configuration diagram of a printing system of an embodiment.

FIG. 2 is a schematic diagram illustrating an example of image data.

FIG. 3 is a flowchart illustrating procedures of color adjustment of a color adjustment method of the embodiment.

FIG. 4 is a schematic diagram of a printer property screen.

FIG. 5 is a schematic diagram of a specified color adjustment tool screen.

FIG. 6 is a diagram illustrating a part of a color sample table as an example.

FIG. 7 is a diagram illustrating an example of a color variable chart.

FIG. 8 is a diagram illustrating patch regions of the color variable chart of FIG. 7.

FIG. 9 is a diagram illustrating a modified color variable chart.

### DESCRIPTION OF EXEMPLARY EMBODIMENTS

An embodiment of a color adjustment method, which is executed by a printing system that prints an image on a medium, will be described with reference to the accompanying drawings.

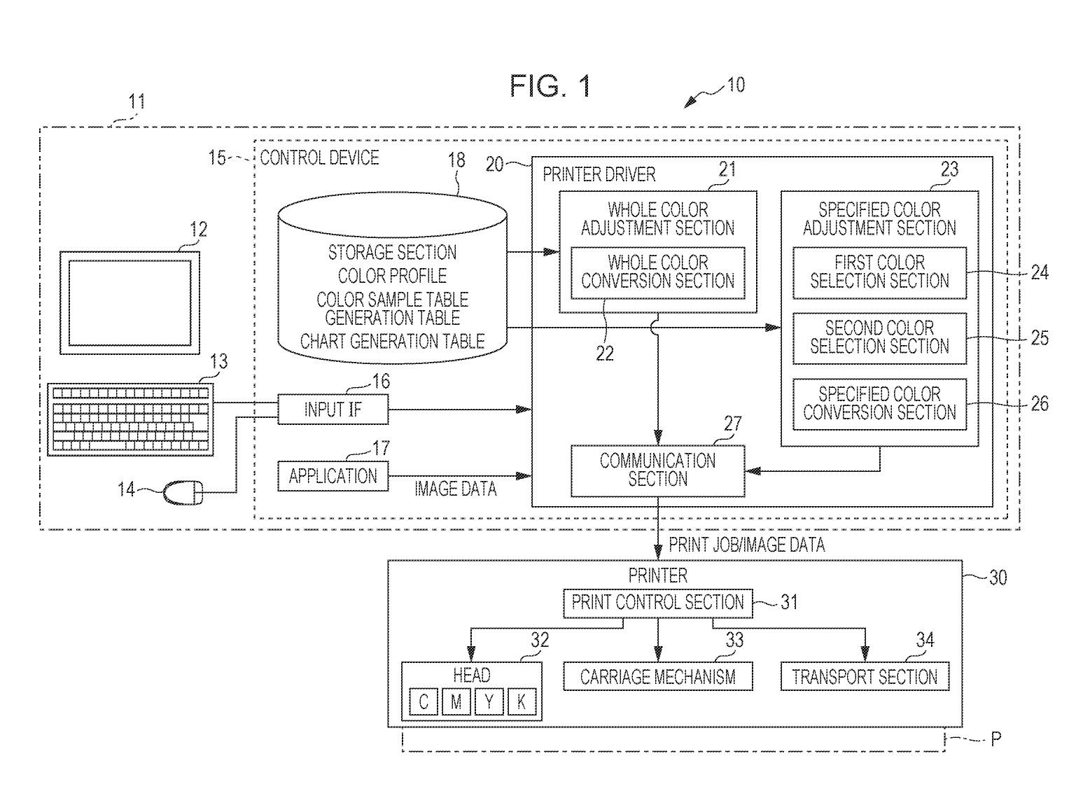

As illustrated in FIG. 1, a printing system 10 includes a personal computer (hereinafter referred to as “the PC”) 11 that functions as a control unit, and a printer 30 as a printing device that prints an image on a roll paper P, which is an example of media, on the basis of a print job and image data transmitted from the PC 11. The printing system 10 can adjust color component values, which are gradation values of image data, such that a color of image data displayed on a display 12 of the PC 11 and a color of an image to be printed on the roll paper P by the printer 30 are matched, and, after the color component values are adjusted, can print the image on the roll paper P by using the printer 30.

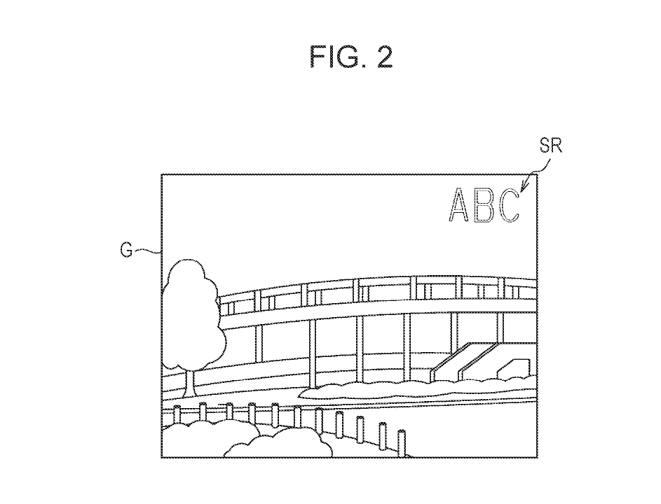

As illustrated in FIG. 2, image data G of an image to be printed on the roll paper P by the printer 30 has a specified region SR in the image area thereof, the specified region being a region to be printed with a specific color (hereinafter referred to as “the specified color”), such as a corporate color. That is, the image data G has a plurality of regions in the image area thereof, each region being a region to be printed with a different color. In the present embodiment, the specified region SR, which is one of such a plurality of regions and in which a company name “ABC” is to be printed with a corporate color, is selected as a color adjustment region where color adjustment is applied when printing.

The printer 30 is an ink jet printer that prints by ejecting an ink, as an example of a liquid, to a roll paper P, and is a so-called serial type printer that prints by moving a liquid ejecting head (hereinafter referred to as “the head”) 32 in a direction intersecting the transport direction of the roll paper P. This printer 30 is formed of a print control section 31, the head 32, a carriage mechanism 33, a transport section 34, and so on.

The head 32 uses a cyan (C) ink, a magenta (M) ink, a yellow (Y) ink, and a black (K) ink and ejects the inks to the roll paper P in such a manner that the amounts of the inks correspond to the color component values of image data. The carriage mechanism 33 is provided with a carriage (not shown) on which the head 32 is mounted, and moves the head 32, together with the carriage, in a direction orthogonal to the transport direction. The transport section 34 is formed of a plurality of rollers (not shown), and, by using these rollers, transports the roll paper P in the transport direction to a support base (not shown) which faces the head 32. The print control section 31 controls the operations of the head 32, the carriage mechanism 33, and the transport section 34 in order to print an image on the roll paper P on the basis of a print job including image data.

The PC 11 is formed of a display 12, a keyboard 13, a mouse 14, a control device 15, and so on.

The control device 15 is provided with a printer driver 20 that instructs the printer 30 to perform printing. An input interface (IF) 16 to which the keyboard 13 and the mouse 14 are connected, application software 17 capable of creating image data including color information, and a storage section 18 in which operation programs for the printer driver 20 and the like are stored are connected via a system bus (not shown) to the printer driver 20. On the basis of the input information from the input IF 16, the application software 17 and the storage section 18, the printer driver 20 creates a print job for instructing the printer 30 to perform printing.

The application software 17 outputs image data obtained by the PC 11 to the printer driver 20.

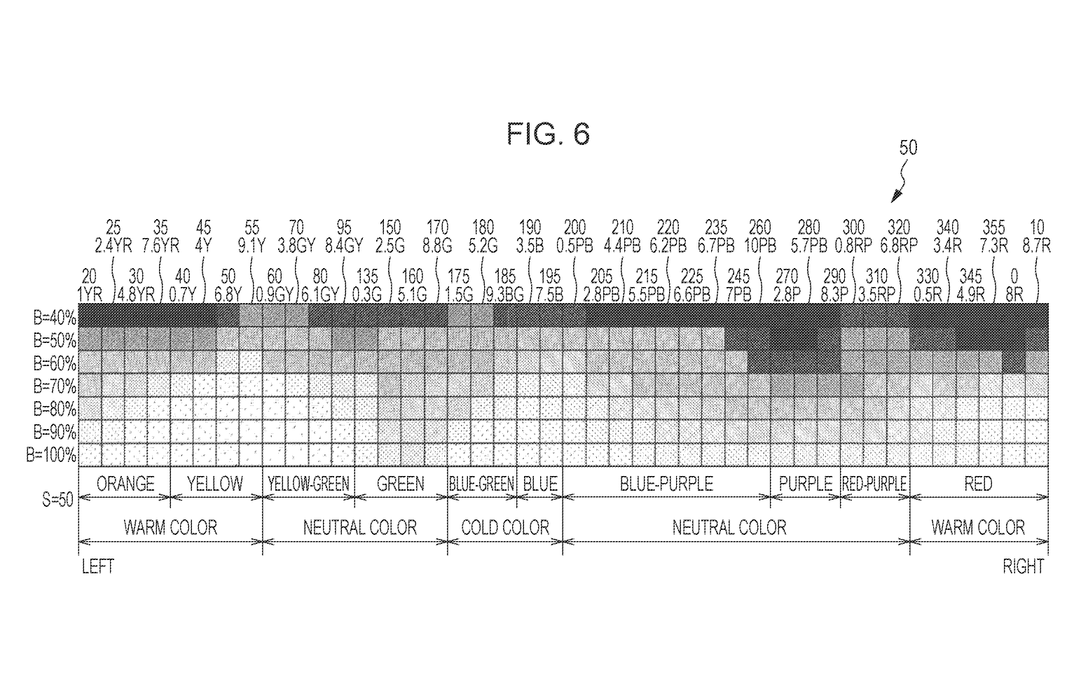

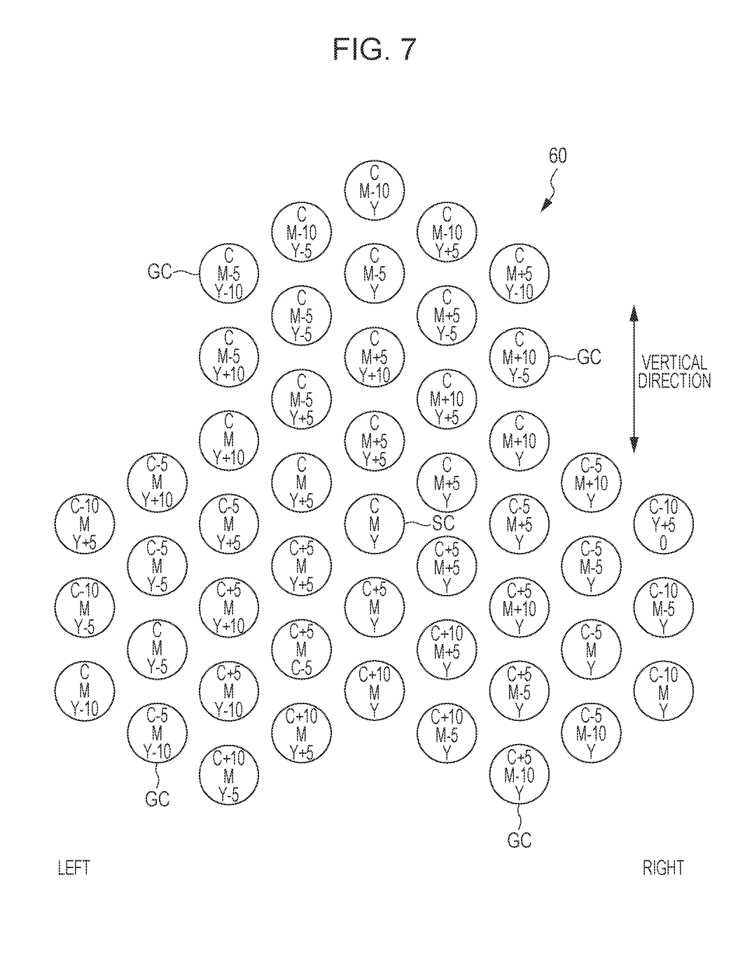

The storage section 18 is formed of a hard disk, a flash memory or the like, and stores a color profile, a color sample table generation table, a chart generation table and so on. The color profile is an information table that defines a correspondence relation between CMYK data before color conversion and CMYK data after color conversion at a plurality of reference points, and is used to correct a color difference between image data of a preview image displayed on the display 12 and an image printed by the printer 30. The color sample table generation table is an information table that is used to generate a color sample table 50 illustrated in FIG. 6, for example. The chart generation table is an information table that is used to generate a color variable chart 60 illustrated in FIG. 7, for example.

The printer driver 20 is formed of a whole color adjustment section 21, a specified color adjustment section 23, a communication section 27, and so on. The printer driver 20 creates print jobs, and also changes a color of image data, which is input from the application software 17, on the basis of operation information of the keyboard 13 and the mouse 14 obtained via the input IF 16 and input information stored in the storage section 18.

The whole color adjustment section 21 includes a whole color conversion section 22 that converts RGB values of the image data G (see FIG. 2) displayed on the display 12 into CMYK values with which the image can be printed by the printer 30, on the basis of the color profile read from the storage section 18.

The specified color adjustment section 23 adjusts only a color of the specified region SR in the image data G, the specified region SR being a region to be printed with a specified color, such as a corporate color, to a color that a user desires. To reduce a difference between the print color of the “ABC”, which is the specified region SR in the image data G of FIG. 2, and the corporate color, which is the specified color, the specified color adjustment section 23 converts the color of the specified region SR in the image data G into a color coinciding with or similar to the specified color.

The specified color adjustment section 23 includes a first color selection section 24 that is used to select, as a first color, a color substantially similar to the color of the specified region SR in the image data G from a plurality of colors in the color sample table 50 read from the storage section 18. The specified color adjustment section 23 also includes a second color selection section 25 that creates a color variable chart 60 in which a plurality of colors are arranged with the first color selected in the first color selection section 24 at the center, on the basis of the chart generation table read from the storage section 18, and is used to select, as a second color, a color to be used for color adjustment of the specified region SR from the color variable chart 60. The specified color adjustment section 23 further includes a specified color conversion section 26 that is a color conversion section for converting the color of the specified region SR in the image data G into the second color (the color coinciding with or similar to the specified color) selected by the second color selection section 25.

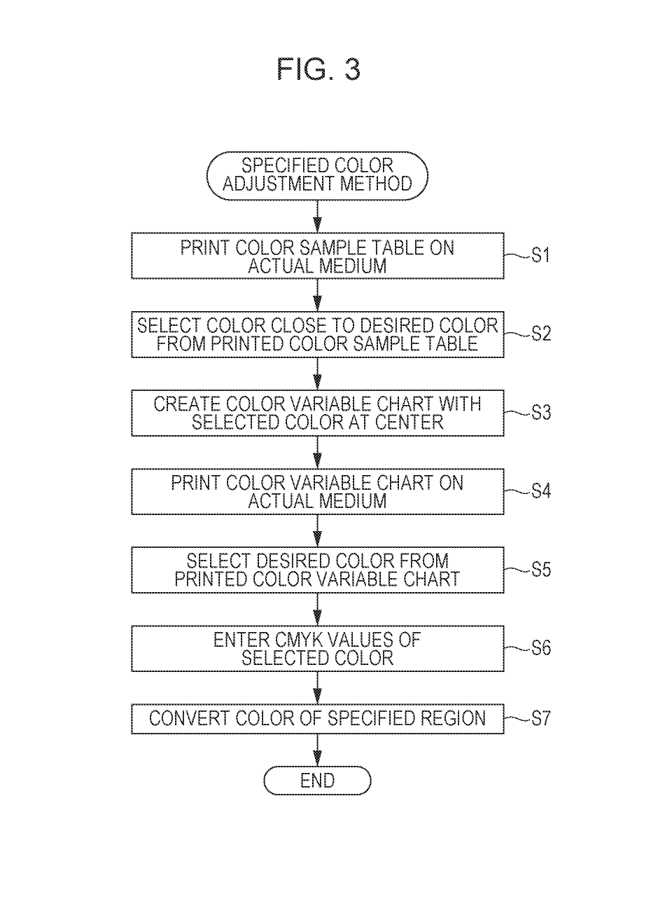

Next, a color adjustment method performed in the printing system 10, in particular, a specified color adjustment method for adjusting only a specified color in image data G will be described by using the flowchart of FIG. 3. Note that, in the following explanations, elements with signs in the printing system 10 denote the elements of the printing system 10 in FIG. 1.

As illustrated in FIG. 3, a specified color adjustment method is carried out through a plurality of processes of: a first color selection process (steps S1 and S2); a color variable chart generation process (step S3); a print process (step S4); a second color selection process (steps S5 and S6); and a color conversion process (step S7), in this order, to convert the color of the specified region SR of FIG. 2 into a color coinciding with or similar to the specified color. A specific procedure will be described below.

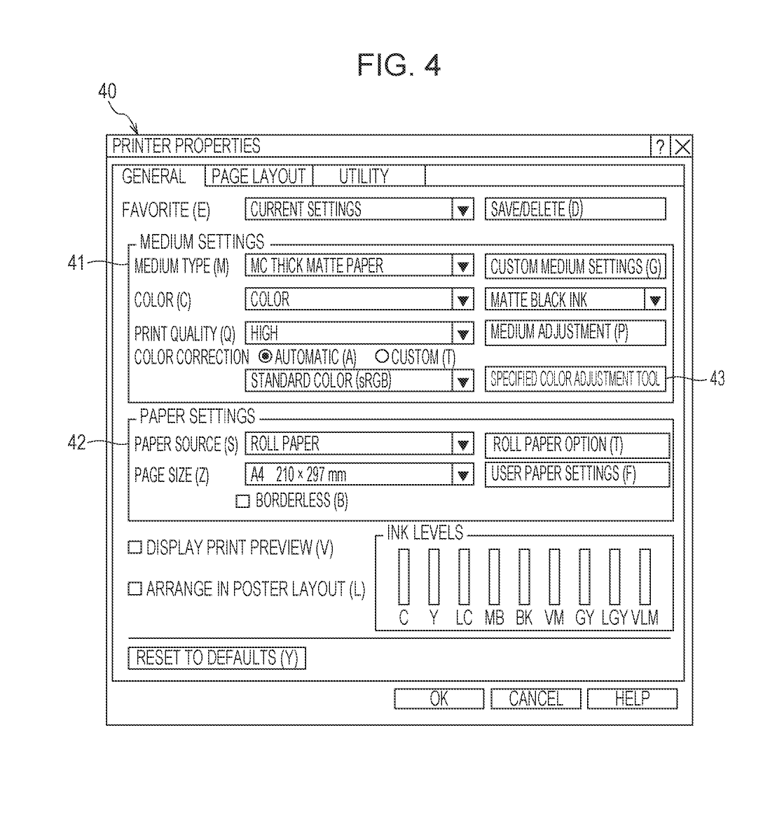

First, a property screen 40 of the printer 30 illustrated in FIG. 4 is displayed on the display 12 of the PC 11 in response to operation by a user. When the user performs an input operation on the property screen 40 to print a color sample table, the printer 30 prints a color sample table 50 of FIG. 6 on an actual medium on which an image based on the image data G will be actually printed (step S1). Specifically, the user sets print operations of the printer 30 from medium settings 41 and paper settings 42 on the property screen 40. More specifically, the user sets medium type, print color (monochrome or color), print quality (high-speed print or high-quality print), and color correction, as the medium settings 41. In color correction, by setting the type of color space, a color profile corresponding to the type of color space is selected. Then, the whole color adjustment section 21 converts the color space by using the selected color profile.

In the embodiment, the media type is set to “MC thick matte paper”, which is used for posters or the like, and the print color is set to “Color” as defaults. In addition, the print quality is set to “High” for high quality printing, and the color correction is set to automatic and the color to be used for the color correction is set to a predetermined standard color (sRGB). Furthermore, for the paper settings 42, the user can set the paper source and the paper size. In the embodiment, the paper source is set to “Roll paper” and the paper size is set to “A4” as defaults.

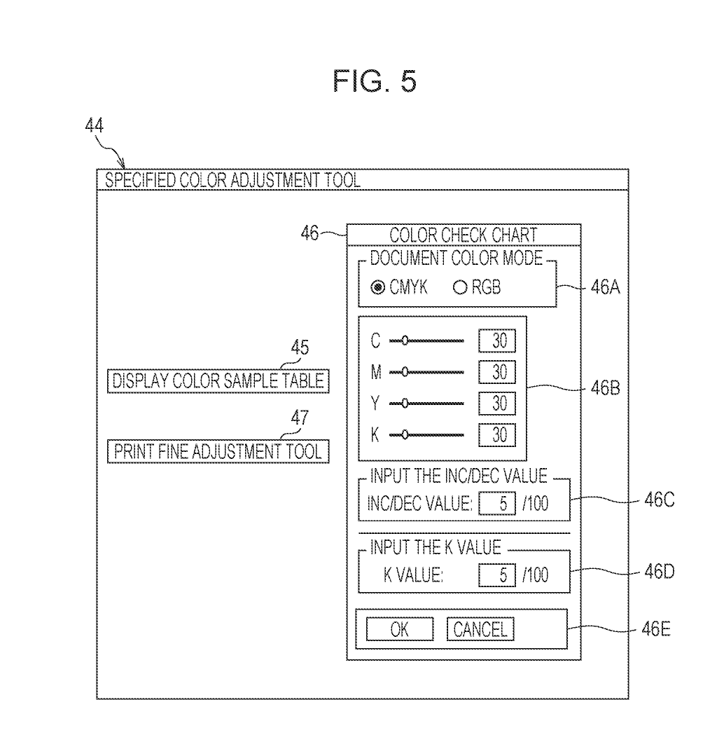

By using a specified color adjustment tool 43 in the medium settings 41, the PC 11 can adjust only a color of a specified region, among image regions in the image data G, selected as a region where color adjustment is required. In the embodiment, the color of the specified region SR in the image data G of FIG. 2 is adjusted so as to become the specified color when printed. Specifically, when the user selects the specified color adjustment tool 43 on the property screen 40, a specified color adjustment tool screen 44 of FIG. 5 is displayed on the display 12 of the PC 11.

Then, when the user selects display color sample table 45 on the specified color adjustment tool screen 44 illustrated in FIG. 5, the color sample table 50 of FIG. 6 is displayed on the display 12 of the PC 11.

As illustrated in FIG. 6, the color sample table 50 is a rectangular color patch table, for example, which is made up of a plurality of color patch images arranged in the horizontal direction and in the vertical direction, and in which the hue is gradually changed in such a manner that hues in the Munsell hue circle are horizontally arranged in a line, and in which the lightness and chroma are gradually changed in the vertical direction. In the color sample table 50, warm colors are used to delimit the color sample table 50, and the hue is changed in the order of, from the left side to the right side in the horizontal direction, a warm color including orange (YR) and yellow (Y), a neutral color including yellow-green (GY) and green (G), a cold color including blue-green (BG) and blue (B), a neutral color including blue-purple (PB), purple (P) and red-purple (RP), and a warm color including red (R). That is, the color sample table 50 is formed in such a manner that the adjacent color patches in the horizontal direction have similar colors.

Furthermore, the color sample table 50 displays all colors that the printer 30 can print, including the colors of the color variable chart 60 (see FIG. 7) described later. That is, a color region of the color sample table 50 is a region where, when a specified color is selected from the color sample table 50 and a color variable chart 60 is created on the basis of the selected color, all colors of the color variable chart 60 can be printed. Consequently, when a color sample table 50 is printed, the printed color sample table 50 includes substantially all the colors, including the colors of the color variable chart 60, that the printer 30 can print.

In the horizontal direction of the color sample table 50, 42 color patches are arranged, and each color patch is provided with an individual number from “0” to “355” as a horizontal position. Except for the color patch with “0”, which is the red color patch at the right end, and the color patch with “10”, which is adjacent to the color patch with “0”, the color patch number increases by “5” from the left end to the right end. The hue value of the colors in the horizontal direction of the color sample table 50 increases from the left side to the right side.

In the vertical direction of the color sample table 50, the lightness (B) is changed in increments of “10%” from “40%” to “100%”. The color sample table 50 illustrated in FIG. 6 is a color sample table with a chroma (S) of “50”, which is a median of the range from “0” to “100”. The chroma (S) may be changed in increments of “10”, for example, and color sample tables with a chroma (S) of “60” or greater and color sample tables with a chroma (S) of “40” or less may be displayed in series one above the other in such a manner that the color sample tables with a chroma (S) of “60” or greater are displayed above the sample color table 50, and the color sample tables with a chroma (S) of “40” or less are displayed below the sample color table 50. As described above, each color patch in the color sample table 50 has a hue value, a lightness value, a chroma value and a position in the horizontal direction as the positional information.

The printer driver 20 can change the hues on both ends of the color sample table 50 in the horizontal direction on the basis of the operation of the keyboard 13 or the mouse 14. For example, if the user adjusts warm colors frequently, the user may set the color sample table 50 such that cold colors delimit the color sample table 50. Consequently, in such a color sample table 50, the hue is changed in the order of, from the left side to the right side in the horizontal direction, a cold color including blue, a neutral color including blue-purple, purple and red-purple, a warm color including red, orange and yellow, a neutral color including yellow-green and green, and a cold color including blue-green. After setting the color sample table 50, the user prints the color sample table 50 by using the printer 30.

Next, by using a sample color medium, which is an actual medium (for example, an MC thick matte paper) on which the specified color is printed, and the color sample table 50 printed on an MC thick matte paper by the printer 30, the user searches for, as a first color, a color similar to the color of the sample color medium from the colors in the color sample table 50 by visual observation. Then, when the user finds out the color (first color) similar to the color of the sample color medium from the color sample table 50, the user selects the color from the color sample table 50 displayed on the display 12 by clicking a color patch having the color in the color sample table 50 by using the mouse 14 (step S2). That is, the user selects the positional information of the color patch in the color sample table 50. Then, on the basis of the chart generation table read from the storage section 18, a color variable chart 60 in which a plurality of colors are arranged with a specified color patch SC, which is the color patch of the selected color (first color), at the center is created (step S3). Note that, when selecting a first color from the color sample table 50, the user may specify a numerical value or the like indicating the selected color.

The color variable chart 60 of FIG. 7 created in step S3 is changed according to each setting set from a document color mode setting section 46A, a value input section 46B, a step number setting section 46C, a K value setting section 46D, and a setting determination section 46E of a color check chart 46 in the specified color adjustment tool screen 44 of FIG. 5.

The document color mode setting section 46A is used to set the display format of the color variable chart 60 to an RGB format or a CMYK format. In the value input section 46B, the contents to be displayed are changed according to a setting result of the document color mode setting section 46A, and RGB values or CMYK values can be entered as the color component values of the color variable chart 60. The step number setting section 46C is used to set a step number, which is the magnitude of change in the RGB values or the CMY values of each color patch in the color variable chart 60. The K value setting section 46D is used to set an amplitude for K value when the CMYK format is selected in the document color mode setting section 46A.

In the embodiment, the CMYK format is selected in the document color mode setting section 46A, and therefore the value input section 46B is displayed such that each value of CMY can be entered therefrom. Also in the embodiment, the step number is set to “5” in the step number setting section 46C, and the amplitude for the K value is set to “5” in the K value setting section 46D.

On the basis of the above settings in the color check chart 46, three types of color variable chart 60, the K values of which are respectively “25”, “30” and “35”, are created. The color variable chart 60 of FIG. 7 is the color variable chart with a K value of “30”, for example.

As illustrated in FIG. 7, the color variable chart 60 includes a specified color patch SC and a plurality of surrounding color patches GC arranged around the specified color patch SC. The plurality of surrounding color patches GC are arranged, with the specified color patch SC at the center, so as to extend to three different directions at an angular interval of 120 degrees. More specifically, in the color variable chart 60, color patches are arranged with, from the left to the right and in the vertical direction, a column of three patches, a column of four patches, a column of seven patches, a column of seven patches, a column of seven patches, a column of seven patches, a column of seven patches, a column of four patches, and a column of three patches.

The chart generation table is a table that indicates changes in the CMY values corresponding to the columns of color patches, and is constructed using coefficients (for example, five coefficients of −2, −1, 0, 1, and 2) indicating changes in the CMY values in the surrounding color patches GC with respect to the specified color patch SC. By adding the values obtained by multiplying the coefficients with the step value to the CMY values of the specified color patch SC, the CMY values of each surrounding color patch GC are calculated. In the embodiment, the step number is “5”, and thus the CMY values of each surrounding color patch GC are changed in the range of −10, −5, 0, 5 and 10 with respect to the CMY values of the specified color patch SC.

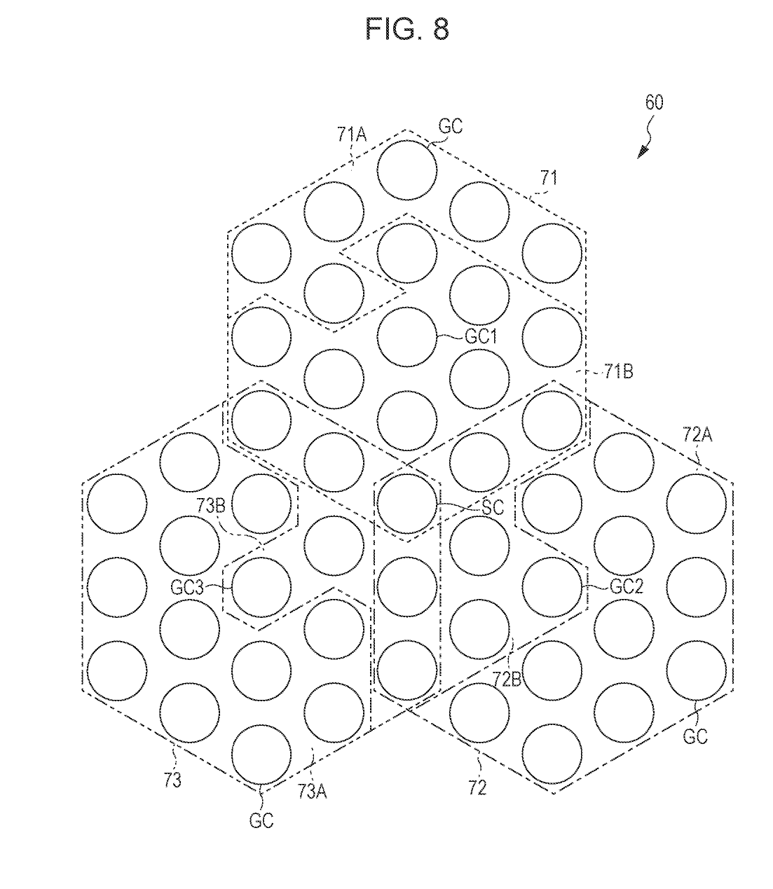

FIG. 8 illustrates regions each of which is divided for each change trend of the CMY values of the color variable chart 60 of FIG. 7. Note that, the CMY values of the surrounding color patches GC of FIG. 8 are not shown in FIG. 8, but correspond to the CMY values of the surrounding color patches GC of FIG. 7.

The color variable chart 60 is formed of a C-value-fixed region 71 surrounded by a broken line, a Y-value-fixed region 72 surrounded by a dashed line, and an M-value-fixed region 73 surrounded by a double-dashed line. The C-value-fixed region 71, the Y-value-fixed region 72, and the M-value-fixed region 73 are formed into hexagonal shapes with predetermined respective surrounding color patches GC1 to GC3 at the centers. The C-value-fixed region 71, the Y-value-fixed region 72, and the M-value-fixed region 73 are arranged in such a manner that each region is adjacent to two other regions and a part of each region overlaps parts of the other regions. In the surrounding color patches GC in the region where the C-value-fixed region 71 and the Y-value-fixed region 72 overlap, the C values and the Y values are fixed and the M values increase as the distance from the specified color patch SC increases. In the surrounding color patches GC in the region where the C-value-fixed region 71 and the M-value-fixed region 73 overlap, the C values and the M values are fixed and the Y values increase as the distance from the specified color patch SC increases. In the surrounding color patches GC in the region where the Y-value-fixed region 72 and the M-value-fixed region 73 overlap, the Y values and the M values are fixed and the C values increase as the distance from the specified color patch SC increases.

In the C-value-fixed region 71, the C value of each surrounding color patch GC is fixed with respect to the CMY values of the specified color patch SC, and at least one of the M value and the Y value of each surrounding color patch GC is changed. The C-value-fixed region 71 is divided into a decreasing region 71A where at least one of the M value and the Y value of each surrounding color patch GC is decreased, and an increasing region 71B where the C value of each surrounding color patch GC is not decreased but at least one of the M value and the Y value thereof is increased. In a direction from the specified color patch SC to the color patch GC1, which is the center of the C-value-fixed region 71, the increasing region 71B and the decreasing region 71A are arranged side by side. The increasing region 71B includes the specified color patch SC and is disposed at an inner side of the color variable chart 60. The decreasing region 71A is disposed at an outer side of the increasing region 71B.

In the Y-value-fixed region 72, the Y value of each surrounding color patch GC is fixed, and at least one of the C value and the M value thereof is changed. The Y-value-fixed region 72 is divided into a decreasing region 72A where at least one of the C value and the M value of each surrounding color patch GC is decreased, and an increasing region 72B where the Y value of each surrounding color patch GC is not decreased but at least one of the C value and the M value thereof is increased. In a direction from the specified color patch SC to the color patch GC2, which is the center of the Y-value-fixed region 72, the increasing region 72B and the decreasing region 72A are arranged side by side. The increasing region 72B which includes the specified color patch SC is disposed at an inner side of the color variable chart 60, and is adjacent to the increasing region 71B in such a manner that a part of the increasing region 72B overlaps a part of the increasing region 71B. The decreasing region 72A is disposed at an outer side of the increasing region 72B.

In the M-value-fixed region 73, the M value of each surrounding color patch GC is fixed, and at least one of the C value and the Y value thereof is changed. The M-value-fixed region 73 is divided into a decreasing region 73A where at least one of the C value and the Y value of each surrounding color patch GC is decreased, and an increasing region 73B where the M value of each surrounding color patch GC is not decreased but at least one of the C value and the Y value thereof is increased. In a direction from the specified color patch SC to the color patch GC3, which is the center of the M-value-fixed region 73, the increasing region 73B and the decreasing region 73A are arranged side by side. The increasing region 73B which includes the specified color patch SC is disposed at an inner side of the color variable chart 60, and is adjacent to the increasing region 71B and the increasing region 72B in such a manner that a part of the increasing region 73B overlaps parts of the increasing region 71B and the increasing region 72B.

Next, when the user selects print fine adjustment tool 47 on the specified color adjustment tool screen 44 of FIG. 5, the printer 30 prints three types of color variable chart 60 having different K values on an MC thick matte paper (step S4). Then, the user uses the printed color variable charts 60 and the sample color medium to search for a color coinciding with (or similar to) the color of the sample color medium from the color variable charts 60 by visual observation (step S5). In the step S5, the user compares the color of the sample color medium with the colors in each color variable chart 60 by moving the sample color medium around the specified color patch SC of each color variable chart 60 and the surroundings thereof. That is, the user compares the color of the sample color medium with the colors of the color variable chart 60 by moving the sample color medium in each of the increasing regions 71B to 73B. If the user cannot find out a color coinciding with (or similar to) the color of the sample color medium from the colors in the increasing regions 71B to 73B, the user then searches for a color coinciding with (or similar to) the color of the sample color medium in the decreasing regions 71A to 73A of the color variable chart 60.

Next, when the user finds out a color coinciding with (or similar to) the color of the sample color medium from the color variable chart 60, the user enters the CMYK values of the color of the color variable chart 60, the color being a color coinciding with (or similar to) the color of the sample color medium, to the value input section 46B of the color check chart 46 of FIG. 5 (step S6). Then, when the user selects “OK” in the setting determination section 46E of the color check chart 46, the specified color conversion section 26 converts the color of the specified region SR into a color having the CMYK values entered in the step S6. Consequently, when the printer 30 prints the image of FIG. 2 on an MC thick matte paper, the color of the specified region SR coincides with (or becomes similar to) the color of the sample color medium.

A color adjustment method of the embodiment will be explained below.

As the image data G of FIG. 2, for example, if an image of the name of a company or an institution is present on a part of the image region, the specified region SR formed of the image of the name is required to coincide with a specified color, which is the corporate color. Therefore, the corporate color (specified color) is often set in Lab values.

Meanwhile, there is a case where the whole color adjustment section 21 adjusts the whole color of the image data G in order to correct a color difference between the image data G displayed on the display 12 and the image printed by the printer 30. In this case, the whole color adjustment section 21 adjusts the color of the specified region SR at the same time, and therefore the color of the specified region SR may become different from the corporate color.

For this reason, in the color adjustment method of the embodiment, the color is adjusted only in the specified region SR by using the specified color adjustment section 23. With this configuration, even if the whole color adjustment section 21 adjusts the color of the specified region SR, the color of the specified region SR can be adjusted to the corporate color.

In addition, even if the whole color of the image data G is adjusted by the whole color adjustment section 21, there is a case where the color of the specified region SR in the image data G displayed on the display 12 and the color of the specified region SR in the image actually printed on a medium may be different from each other. Therefore, if adjustment is performed by using the color of the specified region SR displayed on the display 12, the color of the specified region SR actually printed on a medium may be different from the corporate color. Furthermore, in a case where a metallic color is used for the color of the specified region SR, the shininess of the color is not recognizable from the display 12.

For this reason, in the color adjustment method of the embodiment, the user uses the color sample table 50 and the color variable chart 60 both printed by the printer 30 to compare the colors thereof with the color of the sample color medium indicating the corporate color. As described above, the user performs color matching by comparing the colors printed on the real media, and therefore the color of the specified region SR can be accurately matched with the corporate color.

According to the color adjustment method of the embodiment, the following effects can be obtained.

(1) There is a case where, even if the same Lab values are used, the corporate color printed on a medium may appear differently depending on the type of the medium. For this reason, in the step S1 of the color adjustment method, the color sample table 50 is printed by the printer 30 on an actual medium (roll paper P) of the same type as the sample color medium, and, in the step S4, the color variable chart 60 is printed by the printer 30 on an actual medium (roll paper P) of the same type as the sample color medium. In this way, since the color sample table 50 and the color variable chart 60 are printed on media (roll paper P) of the same type as the sample color medium, the occurrence of a difference in color between the color sample table 50 and the color variable chart 60 printed on actual media and the color sample table 50 and the color variable chart 60 printed on media of a different type is suppressed. Therefore, a difference between the color of the specified region SR in the image data G and the color of the image which is printed on an actual medium on the basis of the image data G can be reduced.

(2) Since a printer prints on a medium after converting Lab values into CMYK values, there is a case where the CMYK values converted from the Lab values may vary depending on the type of printer. In addition, due to processing errors and assembling errors of the components in printers, the distance between a medium and the head may vary in each printer. Therefore, even if the image having the same CMYK values is printed on a medium, the color of the printed image may be slightly different from one printer to another.

For this reason, the printing system 10 prints the color sample table 50 and the color variable chart 60 by using the same printer 30. Consequently, the occurrence of variation in color between the color sample table 50 and the color variable chart 60 due to the printer 30 can be suppressed.

(3) The printer 30 prints the color sample table 50 with all the colors that the printer 30 can print, including the colors of the color variable chart 60. Therefore, the color selection range in the color sample table 50 for the first color selection process can be enlarged.

(4) The color sample table 50 has a configuration in which the Munsell hue circle is arranged in a line. With this configuration, adjacent color patches in the color sample table 50 are arranged in such a manner that the colors thereof are similar to each other, and therefore, the user can find out a color similar to a specified color.

(5) The printer driver 20 has the specified color adjustment section 23. Therefore, compared with a configuration in which, aside from the printer driver 20, an external driver, such as a Raster Image Processor (RIP), on the outside of the PC 11 is provided with a specified color adjustment section 23, the cost of the printing system 10 can be reduced.

(6) In the color variable chart 60, the amplitude for the K value of the surrounding color patches GC is set separately from the step value, which is an amplitude for the CMY values thereof. Therefore, the colors of the color patches in the color variable chart 60 can be changed more specifically.

(7) The color variable chart 60 is formed of the C-value-fixed region 71, the Y-value-fixed region 72, and the M-value-fixed region 73, each of the regions in which one or two of the color component values, CMY values, are fixed in the surrounding color patches GC, and the color component values, except for the fixed value(s), among the three color component values are changed in a direction away from the specified color patch SC. With this configuration, the color patches adjacent to each other in the C-value-fixed region 71, the Y-value-fixed region 72, and the M-value-fixed region 73 have colors similar to each other, thereby allowing the user to easily find out a desired color. Therefore, a desired color can be easily selected in the color variable chart 60.

(8) The color variable chart 60 is formed of the increasing regions 71B to 73B, and the decreasing regions 71A to 73A. In each of the increasing regions 71B to 73B, and in each of the decreasing regions 71A to 73A, the color patches have colors more similar to each other. In addition, since the increasing regions 71B to 73B are formed around the specified color patch SC, the color patches having similar colors are arranged around the specified color patch SC. Therefore, by searching one by one the color patches adjacent to each other in the circumferential direction of the specified color patch SC, a desired color can be found out easily.

(9) Since the specified color patch SC is the color selected in the color sample table 50, and is arranged at the center of the color variable chart 60, a desired color can be found out easily in the color variable chart 60.

The embodiment may be modified as follows.

In the above embodiment, the color sample table 50 and the color variable chart 60 may be printed by using a printer different from the printer 30.

In the above embodiment, the specified color adjustment section 23 may be eliminated from the printer driver 20, and an external driver, such as an RIP (Raster Image Processor), on the outside of the PC 11 may be provided with a specified color adjustment section 23.

In the above embodiment, one specified region SR is selected and the color of the specified region SR is adjusted by the color adjustment method. However, if a plurality of specified regions (SR) are present in image data, colors of the specified regions, the colors being different for each region may be adjusted in the same way.

In the above embodiment, the K value setting section 46D may be eliminated from the color check chart 46. In such a case, the step number of the step number setting section 46C corresponds to the amplitude for the K value.

In the above embodiment, at least one of the color sample table 50 and the color variable chart 60 may be printed on an actual medium having a thickness different from a thickness of the sample color medium. In other words, an actual medium on which the color sample table 50 or the color variable chart 60 is printed may be any medium having the same material and properties (such as ink absorption) as the sample color medium. That is, any medium may be used as long as colors printed on the medium appear the same as the colors of the sample color medium.

In the above embodiment, if an ink cartridge of the printer 30 is replaced, it is preferred that the color sample table 50 and the color variable chart 60 be printed by using an ink of a new ink cartridge after the replacement.

In the above embodiment, when the color variable chart 60 is created, after the RGB values or the Lab values are converted into CMYK values, the color variable chart 60 based on the CMYK values may be created. In such a case, each color patch of the color variable chart 60 includes a K value, and thereby creation of a plurality of color variable charts 60 each having a different K value is eliminated. Therefore, a desired color can be selected from a single color variable chart 60.

The number of the color patches in the color variable chart 60 of the above embodiment may be changed. In addition, the number of columns of the color patches may be changed.

The positions of the increasing regions 71B to 73B and the positions of the decreasing regions 71A to 73A may be switched in the color variable chart 60 of the above embodiment.

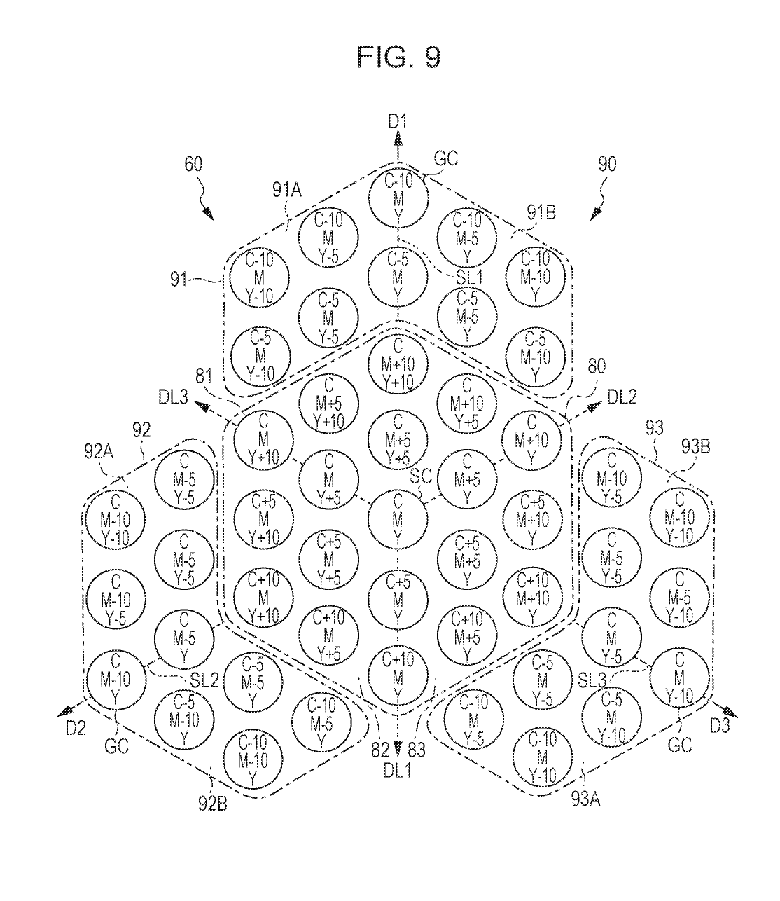

The color variable chart 60 of the above embodiment may be modified as illustrated in FIG. 9. Note that, in the explanations below, C-value-fixed regions 92A, 93B are regions in which a C value of each color patch is fixed and at least one of M value and Y value thereof decreases, M-value-fixed regions 91A, 93B are regions in which an M value of each color patch is fixed and at least one of C value and Y value thereof decreases, and Y-value-fixed regions 91B, 92B are regions in which a Y value of each color patch is fixed and at least one of C value and M value thereof decreases.

The modified color variable chart 60 is formed of an increasing region 80 which is a region for color patches each in which at least one of CMY values thereof is greater than CMY values of a specified color patch SC, and a decreasing region 90 which is a region for color patches each in which at least one of CMY values thereof is smaller than the CMY value of the specified color patch SC.

The increasing region 80 is configured in such a manner that color patches are arranged so as to have larger C, M, and/or Y values in a direction away from a center of the color variable chart 60 toward an outer peripheral side thereof. The increasing region 80 is formed of color patch regions arranged so as to form into a hexagonal shape with the specified color patch SC at a center, and are divided by three broken lines DL1 to DL3. In surrounding color patches GC on the broken line DL1, the C-values increase as the distance from the specified color patch SC increases. In surrounding color patches GC on the broken line DL2, the M-values increase as the distance from the specified color patch SC increases. In surrounding color patches GC on the broken line DL3, the Y-values increase as the distance from the specified color patch SC increases.

The increasing region 80 is divided into a first increasing region 81 to a third increasing region 83 by the broken lines DL1 to DL3. Color patches on the broken line DL1 are included in the second increasing region 82 and the third increasing region 83. Color patches on the broken line DL2 are included in the first increasing region 81 and the third increasing region 83. Color patches on the broken line DL3 are included in the first increasing region 81 and the second increasing region 82.

The first increasing region 81 is formed in a first direction D1 that extends opposite to the broken line DL1 with respect to the specified color patch SC. In each color patch included in the first increasing region 81, the C-value is fixed and at least one of the M value and the Y value increases.

The second increasing region 82 is formed in a second direction D2 that extends opposite to the broken line DL2 with respect to the specified color patch SC. In each color patch included in the second increasing region 82, the M-value is fixed and at least one of the C value and the Y value increases.

The third increasing region 83 is formed in a third direction D3 that extends opposite to the broken line DL3 with respect to the specified color patch SC. In each color patch included in the third increasing region 83, the Y-value is fixed and at least one of the C value and the M value increases.

A decreasing region 90 is formed of three regions, a first decreasing region 91, a second decreasing region 92 and a third decreasing region 93, which are adjacent to the outer peripheral side of the increasing region 80 but are apart from each other. The decreasing region 90 is configured in such a manner that color patches are arranged so as to have smaller C, M, and/or Y values in a direction away from a center of the color variable chart 60 toward an outer peripheral side thereof.

A first decreasing region 91 is arranged at an outer side of the first increasing region 81 in the first direction D1. The first decreasing region 91 is divided into an M-value-fixed region 91A and a Y-value-fixed region 91B by a first dividing line SL1 indicated by a double-dash line. Color patches on the first dividing line SL1 are included in the M-value-fixed region 91A and the Y-value-fixed region 91B. The M-value-fixed region 91A is formed closer to the broken line DL3, and the Y-value-fixed region 91B is formed closer to the broken line DL2.

A second decreasing region 92 is arranged at an outer side of the second increasing region 82 in the second direction D2. The second decreasing region 92 is divided into a C-value-fixed region 92A and a Y-value-fixed region 92B by a second dividing line SL2 indicated by a double-dash line. Color patches on the second dividing line SL2 are included in the C-value-fixed region 92A and the Y-value-fixed region 92B. The C-value-fixed region 92A is formed closer to the broken line DL3, and the Y-value-fixed region 92B is formed closer to the broken line DL1.

A third decreasing region 93 is arranged at an outer side of the third increasing region 83 in the third direction D3. The third decreasing region 93 is divided into an M-value-fixed region 93A and a C-value-fixed region 93B by a third dividing line SL3 indicated by a double-dash line. The M-value-fixed region 93A is formed closer to the broken line DL1, and the C-value-fixed region 93B is formed closer to the broken line DL2.

In the modified color variable chart 60, the position of the increasing region 80 and the position of the decreasing region 90 may be switched. That is, the decreasing region 90 is formed of color patches arranged so as to be formed into a hexagonal shape with the specified color patch SC at a center, and are divided into the first decreasing regions 91 to the third decreasing regions 93 by three broken lines DL1 to DL3. The first decreasing region 91 extents to the first direction D1 with respect to the specified color patch SC, the second decreasing region 92 extents to the second direction D2 with respect to the specified color patch SC, and the third decreasing region 93 extents to the third direction D3 with respect to the specified color patch SC.

The first increasing region 81 of the increasing region 80 is arranged side by side with the first decreasing region 91 in the first direction D1, the second increasing region 82 thereof is arranged side by side with the second decreasing region 92 in the second direction D2, and the third increasing region 83 thereof is arranged side by side with the third decreasing region 93 in the third direction D3.

In the above embodiment, the printer 30 may be of any printer capable of printing on a medium, such as a dot impact printer or a laser printer. In addition, the printer 30 is not limited to a configuration provided only with a printing function but may be a composite machine. Furthermore, the printer 30 is not limited to a serial printer but may be a line printer or a page printer.

The medium is not limited to a roll paper P but may be cutform paper, a resin film, a metallic foil, a metallic film, a composite film (laminated film) of resin and metal, a fabric, a nonwoven fabric, a ceramic sheet, or the like.

States of a liquid to be ejected from the head 32 as a small amount of a droplet include a granular form, a tear-like form, and a thread-like form having a tail. The liquid may be of any material that can be ejected from the head 32. For example, the liquid may be of any material in a liquid phase, and examples of the material include a liquid form having a high or low viscosity, sol, gel, and other fluids such as an inorganic solvent, an organic solvent, a solution, and a liquid resin. The state of a material is not limited to a liquid, but includes a material in which solid particles, such as pigments, are dissolved, dispersed, or mixed in a solvent. If the liquid is an ink, examples of the ink include general aqueous inks and oil-based inks, and various liquid compositions such as a gel ink and a hot-melt ink.

In the above embodiment, the printing system 10 may include an electronic information terminal of a touch panel type, as an alternative to the PC 11. In such a case, the electronic information terminal is provided with a printer driver 20.

The entire disclosure of Japanese Patent Application No. 2014-242872, filed Dec. 1, 2014 is expressly incorporated by reference herein.

What is claimed is:

1. A color adjustment method comprising:
selecting, as a first color, a color of a color adjustment region in an image region of image data, from a color sample table printed on a medium similar to a medium to be used when an image based on the image data is printed;
printing a color variable chart in which a plurality of colors are arranged with the first color at a center, on a medium similar to the medium to be used when the image is printed;
selecting, as a second color, a color to be used for color adjustment in the color adjustment region, from the printed color variable chart; and
converting the color of the color adjustment region in the image data into the second color.

2. The color adjustment method according to claim 1,
wherein the color sample table and the color variable chart are printed by a same printing device.

3. The color adjustment method according to claim 2,
wherein the color sample table is printed so as to include an entire range of colors that the printing device can print, including the color variable chart.

4. The color adjustment method according to claim 1,
wherein, in the color sample table, a plurality of patch images are arranged in a vertical direction and a horizontal direction, and a hue changes along one of the vertical direction and the horizontal direction, and one of a lightness and a chroma changes along the other of the vertical direction and the horizontal direction.

5. The color adjustment method according to claim 4,
wherein, in selecting the first color, a positional information of the patch image in the color sample table is selected.

6. The color adjustment method according to claim 1,
wherein the color variable chart is displayed by using RGB values or CMY values.
